(19) United States
(12) Patent Application Publication
(10) Pub. No.: US 2025/0054297 A1
(43) Pub. Date: Feb. 13, 2025

(54) BUILDING RECOGNITION METHOD AND APPARATUS, AND DEVICE

(71) Applicant: TENCENT TECHNOLOGY (SHENZHEN) COMPANY LIMITED, Shenzhen (CN)

(72) Inventors: Yixin ZHANG, Shenzhen (CN); Yuran YANG, Shenzhen (CN)

(21) Appl. No.: 18/932,227

(22) Filed: Oct. 30, 2024

Related U.S. Application Data
(63) Continuation of application No. PCT/CN2023/128972, filed on Nov. 1, 2023.

(30) Foreign Application Priority Data
Dec. 28, 2022 (CN) 202211702241.1

(51) Int. Cl. G06V 20/10; G06T 17/05; G06V 10/26; G06V 10/56; G06V 10/74; G06V 10/764; G06V 10/774; G06V 10/82; G06V 20/13

(52) U.S. Cl. CPC G06V 20/176; G06T 17/05; G06V 10/26; G06V 10/56; G06V 10/74; G06V 10/764; G06V 10/774; G06V 10/82; G06V 20/13

(57) ABSTRACT

The present disclosure discloses a building recognition method and apparatus, and a device, and relates to the field of maps. The method includes acquiring a to-be-recognized satellite image of a building; performing feature extraction on the satellite image of the building to obtain feature information; generating top surface information according to the feature information to obtain top surface parameter information of the building in the satellite image; generating facade information according to the feature information to obtain facade parameter information of the building in the satellite image; and performing top surface recognition based on the feature information and the top surface parameter information to obtain a top surface recognition result of the building in the satellite image, and performing facade recognition based on the feature information and the facade parameter information to obtain a facade recognition result of the building in the satellite image.

### CROSS-REFERENCE TO RELATED APPLICATIONS

This application is a continuation of PCT Application No. PCT/CN2023/128972 filed on Nov. 1, 2023, which in turn claims priority to Chinese Patent Application No. 202211702241.1, filed to the China National Intellectual Property Administration on Dec. 28, 2022, which are both incorporated by reference in their entireties.

### FIELD

Embodiments of the present disclosure relate to the field of maps, and in particular, to a building recognition technology.

### BACKGROUND

In the field of maps, accuracy and richness of the maps can be improved by re-rendering three-dimensional building models in the maps. Building information of respective buildings in a satellite image of the building may be obtained by recognizing the buildings in the satellite image of the building.

However, in the related art, the building information obtained by recognizing the buildings has low accuracy.

### SUMMARY

Some embodiments provide a building recognition method performed by a computer device. The method includes acquiring a to-be-recognized satellite image of a building; performing feature extraction on the satellite image of the building to obtain feature information; generating top surface information according to the feature information to obtain top surface parameter information of the building in the satellite image; generating facade information according to the feature information to obtain facade parameter information of the building in the satellite image; and performing top surface recognition based on the feature information and the top surface parameter information to obtain a top surface recognition result of the building in the satellite image, and performing facade recognition based on the feature information and the facade parameter information to obtain a facade recognition result of the building in the satellite image.

According to one aspect of the embodiments of the present disclosure, a computer device is provided, the computer device including a processor and a memory, the memory storing a computer program, the computer program being loaded and executed by the processor to implement the above method.

According to one aspect of the embodiments of the present disclosure, a non-transitory computer-readable storage medium is provided, the computer-readable storage medium storing a computer program, the computer program being loaded and executed by a processor to implement the above method.

### BRIEF DESCRIPTION OF THE DRAWINGS

FIG. 1 is a schematic diagram of a solution implementation environment according to some embodiments.

FIG. 2 is a schematic diagram of a building recognition method according to some embodiments.

FIG. 3 is a flowchart of a building recognition method according to some embodiments.

FIG. 4 is a schematic diagram of a building recognition model according to an embodiment of the present disclosure.

FIG. 5 is a schematic diagram of a building recognition result according to an embodiment of the present disclosure.

FIG. 6 is a flowchart of a building recognition method according to another embodiment of the present disclosure.

FIG. 7 is a flowchart of a building recognition method according to another embodiment of the present disclosure.

FIG. 8 is a schematic diagram of a building top surface shape recognition result according to an embodiment of the present disclosure.

FIG. 9 is a schematic diagram of an application method for building information according to an embodiment of the present disclosure.

FIG. 10 is a schematic diagram of a rendered three-dimensional building model according to an embodiment of the present disclosure.

FIG. 11 is a flowchart of a method for training a building recognition model according to an embodiment of the present disclosure.

FIG. 12 is a block diagram of a building recognition apparatus according to an embodiment of the present disclosure.

FIG. 13 is a block diagram of a building recognition apparatus according to another embodiment of the present disclosure.

FIG. 14 is a block diagram of an apparatus for training a building recognition model according to an embodiment of the present disclosure.

FIG. 15 is a block diagram of an apparatus for training a building recognition model according to another embodiment of the present disclosure.

FIG. 16 is a structural block diagram of a computer device according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

Before introduction to the technical solutions of the present disclosure, some related technical knowledge involved in the present disclosure is introduced first. The following related technologies as solutions may be combined with the technical solutions in the embodiments of the present disclosure, all of which fall within the protection scope of the embodiments of the present disclosure. The embodiments of the present disclosure include at least part of the following content.

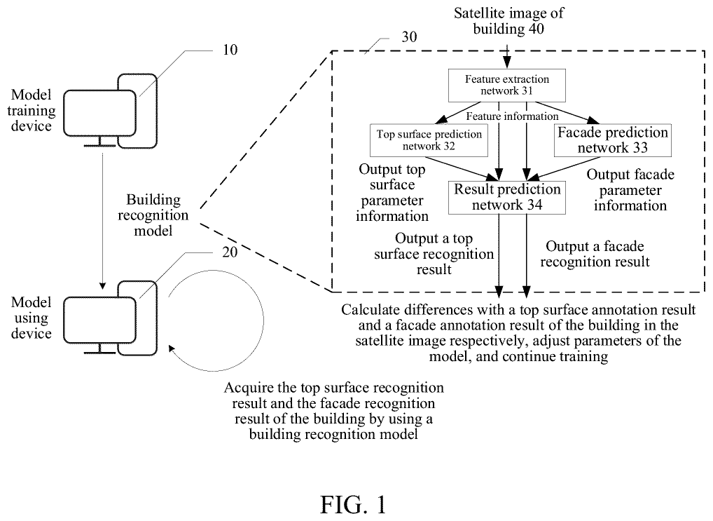

FIG. 1 is a schematic diagram of a solution implementation environment according to some embodiments. The solution implementation environment may include a model training device 10 and a model operating device 20.

The model training device 10 may be an electronic device such as a personal computer (PC), a computer, a tablet computer, a server, or an intelligent robot, or some other electronic devices with high computing capabilities. The model training device 10 is configured to train a building recognition model 30.

In some embodiments, the building recognition model 30 is a machine learning model configured to recognize and deconstruct buildings. For example, the building recognition model 30 is a machine learning model configured to recognize and deconstruct a building in a satellite image of the building. For example, the building recognition model 30 may output, according to an inputted satellite image of the building including a building, a top surface recognition result and a facade recognition result of the building in the satellite image. In some embodiments, the model training device 10 may train the building recognition model 30 by machine learning, so that the building recognition model has better performance.

The trained building recognition model 30 may be deployed in the model operating device 20 for use, to provide recognition and deconstruction results of the building. The model operating device 20 may be a terminal device such as a mobile phone, a computer, a smart TV, a multimedia playback device, a wearable device, or an exploration device, or may be a server, which is not limited in the present disclosure.

In some embodiments, as shown in FIG. 1, the building recognition model 30 may include a feature extraction network 31, a top surface prediction network 32, a facade prediction network 33, and a result prediction network 34.

In some embodiments, training samples are constructed by taking the satellite image of the building including the building as sample data and a top surface annotation result and a facade annotation result of the building in the satellite image as label data, to train the building recognition model 30.

In one embodiment, the satellite image of the building 40 is inputted to the feature extraction network 31 of the building recognition model 30 to acquire feature information, and the feature information passes through the top surface prediction network 32 to obtain top surface parameter information. A top surface output result is obtained through the result prediction network 34 according to the feature information obtained by the feature extraction network 31 and the top surface parameter information. Similarly, the feature information passes through the facade prediction network 33 to acquire facade parameter information. A facade output result is obtained through the result prediction network 34 according to the feature information obtained by the feature extraction network 31 and the facade parameter information. Parameters of the building recognition model 30 are adjusted according to a difference between the top surface recognition result and top surface annotation information and a difference between the facade recognition result and facade annotation information, and the building recognition model 30 is continuously trained with the training samples. Therefore, the trained building recognition model may output the top surface recognition result and the facade recognition result of the building according to the satellite image of the building including the building.

In the method provided in this embodiment of the present disclosure, operations may be performed by a computer device. The computer device is an electronic device with data computing, processing, and storage capabilities. The computer device may be a terminal device such as a PC, a tablet computer, a smartphone, a wearable device, a smart robot, a smart home appliance, a vehicle-mounted terminal, or an aircraft; or may be a server. The server may be an independent physical server, or may be a server cluster including a plurality of physical servers or a distributed system, or may be a cloud server providing a cloud computing service. The computer device may be the model training device 10 or the model operating device 20 in FIG. 1.

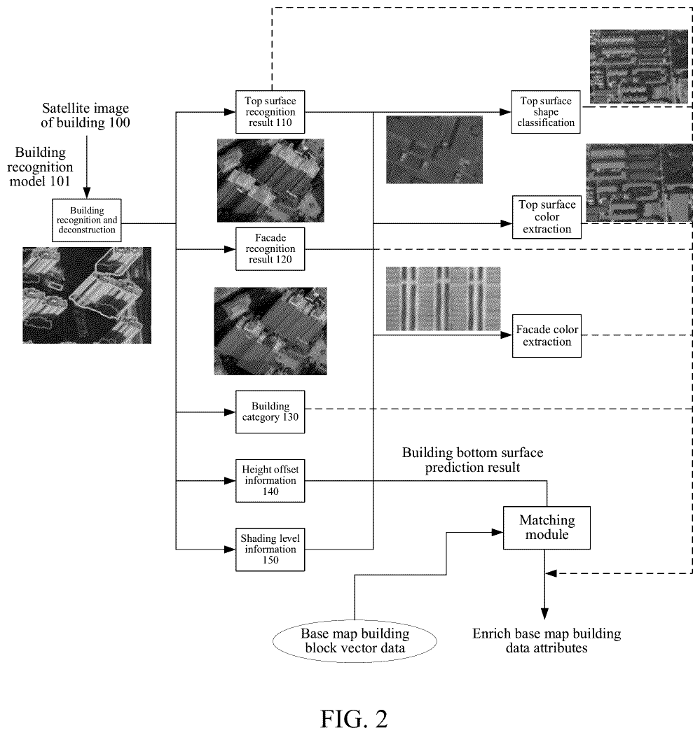

Referring to FIG. 2, which is a flowchart of a building recognition method according to an embodiment of the present disclosure, FIG. 2 is mainly based on an example in which the building recognition method is implemented based on a building recognition model.

Firstly, a satellite image of the building 100 including a to-be-recognized building is acquired. Building recognition and deconstruction are performed on the satellite image of the building 100 through a building recognition model 101. In one embodiment, a top surface recognition result 110, a facade recognition result 120, a building category 130, height offset information 140, and shading level information 150 that correspond to the satellite image of the building 100 are acquired through the building recognition model 101.

In one embodiment, for the satellite image of the building 100, a top surface shape classification result is acquired, and a top surface color is extracted at the same time. In one embodiment, for the satellite image of the building 100, the facade recognition result 120 is acquired, and a facade color is extracted based on the shading level information 150.

In one embodiment, a bottom surface prediction result of the building is determined according to the facade recognition result 120 and the height offset information 140. At the same time, the bottom surface prediction result is matched with base map building block vector data to determine a matching target building from the base map building block vector data.

In one embodiment, based on the base map building block vector data of the matching target building and based on the top surface recognition result 110, the facade recognition result 120, the extracted top surface color and facade color, and the building category 130, base map building data attributes are enriched, and a three-dimensional building model of the target building is further re-rendered.

In related technologies, a building in a satellite image is recognized based on a semantic segmentation method. For example, by using a model such as deeplab-v3 or segformer, the building is finally recognized only at a pixel level and then is clustered to obtain an instance of the entire building or of a top surface of the building. Besides, in some solutions, an instance segmentation method is directly adopted. For example, a deep learning model such as mask r-cnn or blendMask is used to directly recognize the building to obtain the instance of the entire building or of the top surface of the building. In the related technologies, when the building is recognized, the building may be recognized only at a pixel semantic level, or instances of the entire building and the top surface of the building are recognized, but a lateral facade, a height offset, a category, and shading intensity of the building are not comprehensively recognized. Therefore, recognition and deconstruction of the building are not comprehensive enough, and it is difficult to achieve further deconstruction of the building, such as extraction of a color of the lateral facade.

In the technical solution provided in this embodiment of the present disclosure, an innovative improvement may be made based on an existing deep learning model CondInst. Different branch structures and model training are added to finally realize that only one model is needed to end-to-end recognize a top surface, a lateral facade (which may also be referred to as a facade), a height offset, a building category, and shading intensity (which may also be referred to as shading level information) of the building. In this way, facade and top surface colors, a top surface shape, and the like of the building can be extracted according to the shading intensity, thereby realizing fine deconstruction of the building. This may be configured to prime and render map building data, thereby enriching attributes of the map building data.

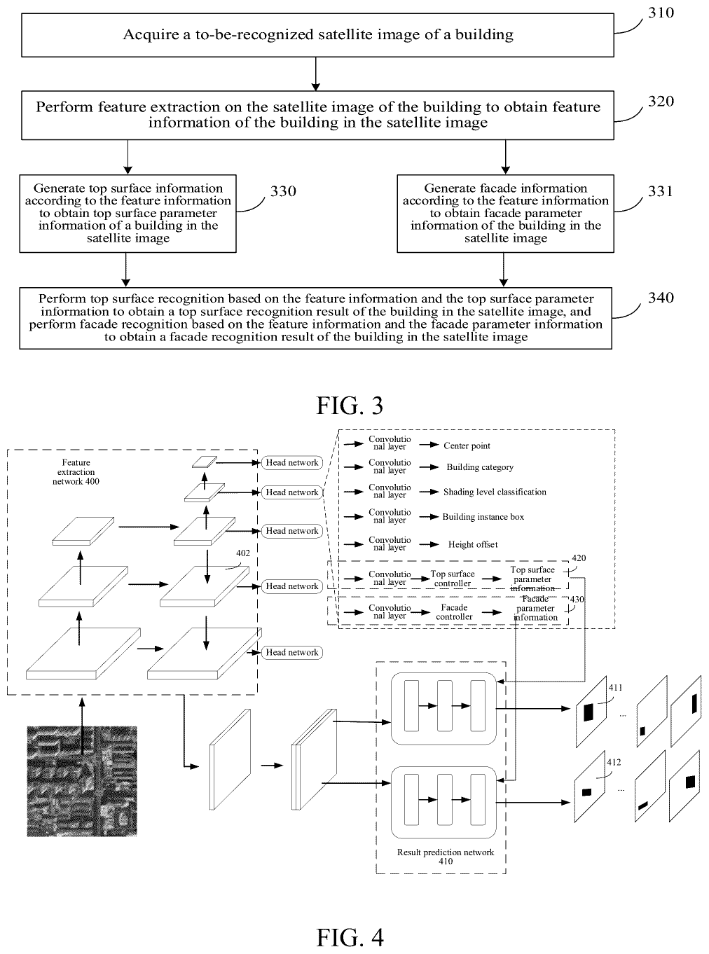

FIG. 3 is a flowchart of a building recognition method according to an embodiment of the present disclosure. Operations of the method may be performed by the model operating device introduced above. In the following method embodiments, for ease of description, the introduction is only based on an example in which the operations are performed by a “computer device”. The computer device may be used as the model operating device. The method may include at least one of the following operations (310 to 340):

Operation 310: Acquire a to-be-recognized satellite image of the building.

In some embodiments, the satellite image of the building is data that comprehensively, truly, and objectively reflects features of a surface building acquired by using a satellite loaded with various sensors. Such data is processed through a professional remote sensing technology and becomes a satellite image of the building with high-precision geographical coordinate information.

In some embodiments, after the sensors acquire the data reflecting the features of the surface building, the data is processed by the satellite to obtain the satellite image of the building, and the satellite image of the building is transmitted to the above computer device.

In some embodiments, the satellite image of the building includes at least one building.

Operation 320: Perform feature extraction on the satellite image of the building to obtain feature information of the satellite image of the building.

In one embodiment, the building recognition method may be implemented based on a building recognition model. In some embodiments, the building recognition model is a deep learning model, and specific architecture of the building recognition model is not limited in the present disclosure. In one embodiment, the building recognition model includes at least one of a feature extraction network, a top surface prediction network, a facade prediction network, and a result prediction network. Specific connection methods of the feature extraction network, the top surface prediction network, the facade prediction network, and the result prediction network are not limited in this embodiment of the present disclosure.

In this case, feature extraction is performed on the satellite image of the building, and a method of obtaining the feature information of the satellite image of the building may be to perform feature extraction on the satellite image of the building through the feature extraction network to obtain the feature information of the satellite image of the building.

In some embodiments, the feature extraction network includes a backbone network and a feature pyramid network (FPN) connected to the backbone network. In some embodiments, in the field of CV, there is a need to perform feature extraction on an image, and the backbone network+the FPN is intended to perform feature extraction on the image. In one embodiment, the feature information of the satellite image of the building is extracted by using the backbone network+the FPN. In one embodiment, the feature extraction network 400 as shown in FIG. 4 performs feature extraction on the satellite image of the building. In one embodiment, firstly, the satellite image of the building is downsampled to obtain a plurality of images with dimensions smaller than an original size of the satellite image of the building. Each image passes through the FPN, and an image feature corresponding to the image is extracted. In one embodiment, after feature information 402 is acquired, the feature information 402 is downsampled to obtain feature information with a lower dimension. In one embodiment, after the feature information 402 is acquired, the feature information is upsampled to obtain feature information with a higher dimension. In one embodiment, the feature extraction network outputs at least one piece of feature information. In one embodiment, the feature information outputted by the feature extraction network affects each other and is associated with each other. To be specific, through the introduction of the backbone network+the FPN, the output feature information is integrated with information with more dimensions, which makes the outputted feature information richer. In some embodiments, each piece of feature information output needs to be predicted by a plurality of subsequent prediction networks.

In some embodiments, the top surface prediction network is a head network. In one embodiment, the head network of the top surface prediction network includes a top surface controller. In one embodiment, the head network of the top surface prediction network further includes at least one convolutional layer.

In some embodiments, the facade prediction network is a head network. In one embodiment, the head network of the facade prediction network includes a facade controller. In one embodiment, the head network of the facade prediction network further includes at least one convolutional layer.

In some embodiments, the result prediction network is a head network. In one embodiment, the head network of the result prediction network further includes at least one convolutional layer.

Operation 330: Generate top surface information according to the feature information to obtain top surface parameter information of a building in the satellite image of the building.

In one embodiment, a method of generating the top surface information according to the feature information to obtain the top surface parameter information of the building in the satellite image may be to generate the top surface information through the top surface prediction network according to the feature information to obtain the top surface parameter information of the building in the satellite image.

In some embodiments, the top surface parameter information is configured to determine convolution parameters that participate in subsequent operations of the result prediction network. In some embodiments, the top surface prediction network is configured to determine the top surface parameter information of the building in the satellite image according to the feature information. In one embodiment, for example, a quantity of parameters of the result prediction network is x, and top surface parameter information with a dimension of x is generated for each building in the satellite image of the building through the top surface prediction network according to the feature information. In one embodiment, for example, the quantity of the parameters of the result prediction network is 169, and top surface parameter information with a dimension of 169 is generated for each building in the satellite image of the building through the top surface prediction network according to the feature information. In one embodiment, when a quantity of buildings in the satellite image of the building is a, top surface parameter information with a dimension of x is generated for each building. In one embodiment, top surface parameter information with a dimension of a*x is generated for “a” buildings. x and a are positive integers.

Operation 331: Generate facade information according to the feature information to obtain facade parameter information of the building in the satellite image.

In one embodiment, a method of generating the facade information according to the feature information to obtain the facade parameter information of the building in the satellite image may be to generate the facade information through the facade prediction network according to the feature information to obtain the facade parameter information of the building in the satellite image.

In some embodiments, the facade parameter information is configured to determine convolution parameters that participate in subsequent operations of the result prediction network. In some embodiments, the facade prediction network is configured to determine the facade parameter information of the building in the satellite image according to the feature information. In one embodiment, for example, a quantity of parameters of the result prediction network is x, and facade parameter information with a dimension of x is generated for each building in the satellite image of the building through the facade prediction network according to the feature information. In one embodiment, for example, a quantity of parameters of the result prediction network is 169, and facade parameter information with a dimension of 169 is generated for each building in the satellite image of the building through the facade prediction network according to the feature information. In one embodiment, when a quantity of buildings in the satellite image of the building is a, facade parameter information with a dimension of x is generated for each building. In one embodiment, facade parameter information with a dimension of a*x is generated for a buildings.

A sequence of operation 330 and operation 331 is not limited in this embodiment of the present disclosure. In one embodiment, operation 330 is first performed, followed by operation 331. In one embodiment, operation 330 and operation 331 are performed simultaneously.

Operation 340: Perform top surface recognition based on the feature information and the top surface parameter information to obtain a top surface recognition result of the building in the satellite image, and perform facade recognition based on the feature information and the facade parameter information to obtain a facade recognition result of the building in the satellite image.

In one embodiment, a method of performing top surface recognition based on the feature information and the top surface parameter information to obtain the top surface recognition result of the building in the satellite image, and performing facade recognition based on the feature information and the facade parameter information to obtain the facade recognition result of the building in the satellite image may be to perform top surface recognition through the result prediction network based on the feature information and the top surface parameter information to obtain the top surface recognition result of the building in the satellite image, and perform facade recognition through the result prediction network based on the feature information and the facade parameter information to obtain the facade recognition result of the building in the satellite image.

In some embodiments, the result prediction network determines the top surface recognition result of the building in the satellite image according to the feature information and the top surface parameter information. In one embodiment, as shown in FIG. 4, the result prediction network 410 determines a top surface recognition result 411 of the building in the satellite image according to the feature information and the top surface parameter information (the top surface parameter information is predicted by the top surface prediction network 420). In one embodiment, when the quantity of the building in the satellite image is a, the result prediction network determines a top surface recognition result of each building in the satellite image of the building according to the feature information and top surface parameter information of the building, i.e., top surface recognition results of the a buildings are obtained. In one embodiment, the top surface recognition result is displayed in a form of a polygon. In one embodiment, the top surface recognition result marks a top surface of the building in a form of a polygon on the satellite image of the building.

In some embodiments, the result prediction network determines the facade recognition result of the building in the satellite image according to the feature information and the facade parameter information. In one embodiment, as shown in FIG. 4, the result prediction network 410 determines a facade recognition result 412 of the building in the satellite image according to the feature information and the facade parameter information (the facade parameter information is predicted by the facade prediction network 430). In one embodiment, when the quantity of the building in the satellite image is a, the result prediction network determines a facade recognition result of each building in the satellite image of the building according to the feature information and facade parameter information of the building, i.e., facade recognition results of the a buildings are obtained. In one embodiment, the facade recognition result is displayed in a form of a polygon. In one embodiment, the facade recognition result marks a facade of the building in a form of a polygon on the satellite image of the building.

In some embodiments, as shown in FIG. 4, each head network may be considered as a head network, and each head network includes the top surface prediction network 420 and the facade prediction network 430 described above. Moreover, the top surface prediction network 420 includes a top surface controller, and the facade prediction network 430 includes a facade controller.

In one embodiment, the result prediction network is a mask branch head or a mask head and is configured to generate a full mask map. The result prediction network is configured to predict an instance foreground pixel probability by using relu activation and sigmoid after a feature layer that has passed through the FPN is convolved with convolution parameters generated by the corresponding controller. Two categories of foregrounds may be generated herein: a top surface and a lateral facade of the building.

In some embodiments, the building recognition model includes a center-ness head prediction network. The center-ness head prediction network is configured to predict a center point position of each building. In one embodiment, a center point of the building in the satellite image is obtained through the center-ness head prediction network according to the feature information.

In some embodiments, the center-ness head prediction network is a head network. In one embodiment, the head network of the center-ness head prediction network further includes at least one convolutional layer. In one embodiment, the center-ness head prediction network is configured to predict a distance between each point and a target center point and reduce predicted points that are far away from the target center point.

In some embodiments, the building recognition model includes a box prediction network. The box prediction network is configured to predict the position of an instance box where each building is located. In one embodiment, an instance box where the building in the satellite image is located is obtained through the box prediction network according to the feature information. In one embodiment, the instance box is a minimum rectangular box enclosing the building. The instance box may be represented as a box. Therefore, in one embodiment, the box prediction network may be a box regression head.

In one embodiment, the above center point position may be a center point of the instance box. In one embodiment, the box prediction network is configured to predict rectangular box coordinates of a building instance.

In some embodiments, the box prediction network is a head network. In one embodiment, the head network of the box prediction network further includes at least one convolutional layer.

In some embodiments, the building recognition model includes a building category prediction network. The building category prediction network is configured to predict a building category to which each building belongs. In one embodiment, a category to which the building in the satellite image belongs is obtained through the building category prediction network according to the feature information.

In some embodiments, the building category prediction network is a head network. In one embodiment, the head network of the building category prediction network further includes at least one convolutional layer. In one embodiment, the building category prediction network outputs categories to which respective buildings in the satellite image of the building belong and respective probabilities according to the feature information. In one embodiment, the category with the highest probability is taken as final output of the building category prediction network.

In one embodiment, building information of the building in the satellite image is determined according to the output of the prediction network above. In one embodiment, the building information includes a top surface recognition result and a facade recognition result. In one embodiment, the building information further includes, but is not limited to, a center point of the building, an instance box of the building, and a category to which the building belongs.

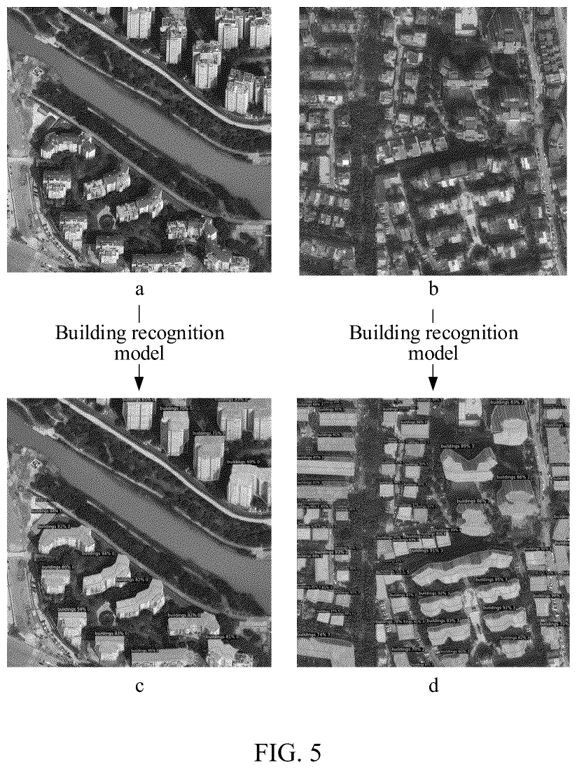

As shown in FIG. 5, Subfigure a and Subfigure b are satellite image of the buildings in different regions. Subfigure a passes through the building recognition model to obtain recognized building information as shown in Subfigure c. Subfigure b passes through the building recognition model to obtain recognized building information as shown in Subfigure d. In one embodiment, Subfigure c includes a top surface recognition result, a side recognition result, a bottom surface recognition result, and a building type prediction result for the building in Subfigure a. In one embodiment, a top surface, a facade, a side, and a category of the building are annotated on Subfigure a through the building recognition model according to the top surface recognition result, the side recognition result, the bottom surface recognition result, and the building type prediction result for the building in Subfigure a, to obtain Subfigure c. In one embodiment, Subfigure d includes a top surface recognition result, a side recognition result, a bottom surface recognition result, and a building type prediction result for the building in Subfigure b. In one embodiment, a top surface, a facade, a side, and a category of the building are marked on Subfigure b through the building recognition model according to the top surface recognition result, the side recognition result, the bottom surface recognition result, and the building type prediction result for the building in Subfigure b, to obtain Subfigure d. In one embodiment, top surfaces, facades, bottom surfaces, and categories of respective buildings are annotated with different colors, different transparency, or different lines.

In the technical solution provided in this embodiment of the present disclosure, after a to-be-recognized satellite image of the building is acquired, feature extraction may be performed on the satellite image of the building to obtain feature information. In order to recognize the building from different dimensions, top surface information may be generated according to the feature information to obtain top surface parameter information of the building in the satellite image, and facade information may be generated according to the feature information to obtain facade parameter information of the building in the satellite image. Then, top surface recognition is performed based on the feature information and the top surface parameter information to obtain a top surface recognition result, and facade recognition is performed based on the feature information and the facade parameter information to obtain a facade recognition result. The building in the satellite image is not recognized as a whole, but is divided into two aspects: a top surface and a facade, to obtain the top surface recognition result and the facade recognition result. Generally, the top surface and the facade of the building vary greatly, and if the top surface and the facade are lumped together, the building in the satellite image may be recognized as a whole, which may reduce accuracy of the obtained building recognition result. Therefore, according to the technical solutions provided in this embodiment of the present disclosure, the top surface recognition result and the facade recognition result are acquired by the building recognition model, which can improve accuracy of building information obtained based on the satellite image of the building, thereby realizing fine deconstruction of the building.

In addition, the building information acquired based on the building recognition model and including the top surface recognition result and the facade recognition result may be configured for subsequent re-rendering of the three-dimensional building model. Therefore, when fine deconstruction of the building is implemented and the acquired building information is relatively accurate, the re-rendered three-dimensional building model may be more accurate and vivid and more in line with an actual building.

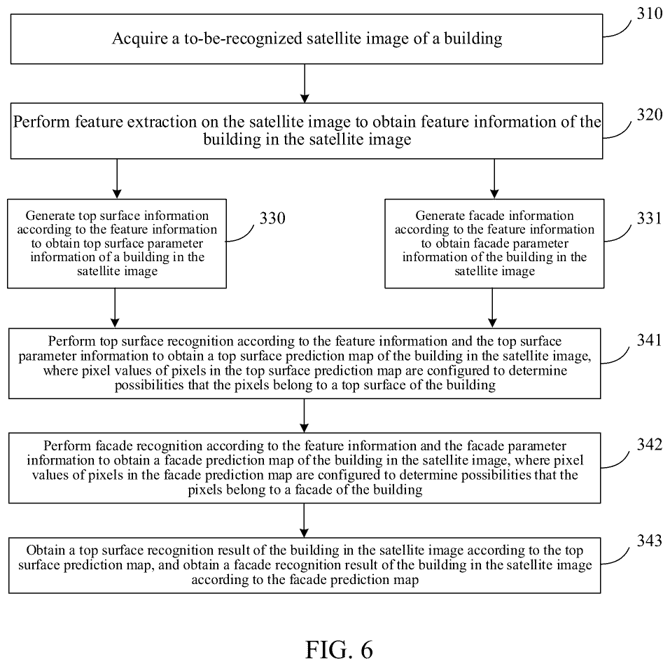

FIG. 6 is a flowchart of a building recognition method according to another embodiment of the present disclosure. Operations of the method may be performed by the model operating device introduced above. In the following method embodiments, for ease of description, the introduction is only based on an example in which the operations are performed by a “computer device”. The computer device may be used as the model operating device. The method may include at least one of the following operations (310 to 343):

Operation 310: Acquire a to-be-recognized satellite image of the building.

Operation 320: Perform feature extraction on the satellite image of the building to obtain feature information of the satellite image of the building.

Operation 330: Generate top surface information according to the feature information to obtain top surface parameter information of a building in the satellite image of the building.

Operation 331: Generate facade information according to the feature information to obtain facade parameter information of the building in the satellite image.

Operation 341: Perform top surface recognition according to the feature information and the top surface parameter information to obtain a top surface prediction map of the building in the satellite image, where pixel values of pixels in the top surface prediction map are configured to determine possibilities that the pixels belong to a top surface of the building.

In some embodiments, the top surface prediction map may alternatively be considered as a matrix of pixel values corresponding to respective pixel points. In one embodiment, the top surface prediction map is a pixel matrix of b*c. A value of each element is configured to represent a possibility that the pixel corresponding to the element belongs to the top surface of the building. b and c are positive integers. In one embodiment, b=c=128. In one embodiment, a range of the pixel value is not limited.

In one embodiment, when top surface recognition is performed through the result prediction network, a method of performing top surface recognition according to the feature information and the top surface parameter information to obtain the top surface prediction map of the building in the satellite image may be to perform top surface recognition through the result prediction network according to the feature information and the top surface parameter information to obtain the top surface prediction map of the building in the satellite image.

Operation 342: Perform facade recognition according to the feature information and the facade parameter information to obtain a facade prediction map of the building in the satellite image, where pixel values of pixels in the facade prediction map are configured to determine possibilities that the pixels belong to a facade of the building.

In some embodiments, the facade prediction map may alternatively be considered as a matrix of pixel values corresponding to respective pixel points. In one embodiment, the facade prediction map is a pixel matrix of b*c. A value of each element is configured to represent a possibility that the pixel corresponding to the element belongs to the facade of the building. b and c are positive integers. In one embodiment, b=c=128. In one embodiment, a range of the pixel value is not limited.

In one embodiment, when top surface recognition is performed through the result prediction network, a method of performing facade recognition according to the feature information and the facade parameter information to obtain the facade prediction map of the building in the satellite image may be to perform facade recognition through the result prediction network according to the feature information and the facade parameter information to obtain the facade prediction map of the building in the satellite image. Operation 343: Obtain a top surface recognition result of the building in the satellite image according to the top surface prediction map, and obtain a facade recognition result of the building in the satellite image according to the facade prediction map.

In some embodiments, background information and top surface information of a building may be distinguished according to the top surface prediction map. In one embodiment, a range of the top surface is expressed with a polygon to represent the top surface recognition result.

In some embodiments, background information and facade information of a building may be distinguished according to the facade prediction map. In one embodiment, a range of the facade is expressed with a polygon to represent the facade recognition result.

In one embodiment, the top surface recognition result and the facade recognition result are expressed in different manners for differentiation. In one embodiment, the top surface recognition result and the facade recognition result are represented by different colors, different transparency, or different lines. Specific expression forms of the top surface recognition result and the facade recognition result are not limited in the present disclosure.

In some embodiments, operation 343 includes at least one of operation 343-1 to operation 343-3 (not shown).

Operation 343-1: Normalize the pixel values of the pixels in the top surface prediction map to obtain a processed top surface prediction map, and normalize the pixel values of the pixels in the facade prediction map to obtain a processed facade prediction map.

In some embodiments, the pixel values of the pixels in the top surface prediction map and the facade prediction map may be randomly distributed. In one embodiment, the pixel values of the pixels in the top surface prediction map and the facade prediction map are normalized to obtain the processed top surface prediction map and the processed facade prediction map. In one embodiment, the pixel values of the pixels in the top surface prediction map and the facade prediction map are normalized to values between 0 and 1.

The operation of obtaining the processed top surface prediction map and the operation of obtaining the processed facade prediction map may be performed simultaneously, or may certainly be performed separately, which is not limited in this embodiment of the present disclosure. For example, the operation of obtaining the processed top surface prediction map may be first performed, operation 343-2 is then performed by using the processed top surface prediction map, the operation of obtaining the processed facade prediction map is performed, and operation 343-3 is performed by using the processed facade prediction map.

Operation 343-2: Set the pixel value in the processed top surface prediction map and greater than a first threshold to a first value and set the pixel value less than the first threshold to a second value to obtain a top surface mask map, the top surface mask map being configured to represent the top surface recognition result.

In some embodiments, the first threshold is 0.5, the first value is 1, and the second value is 0. In one embodiment, the pixel value in the processed top surface prediction map and greater than 0.5 is set to 1, the pixel value less than 0.5 is set to 0 to obtain a top surface mask map, and the top surface mask map is configured to represent the top surface recognition result. In one embodiment, the pixel value in the processed top surface prediction map and equal to the first threshold is set to the second value or the first value. To be specific, the pixel value in the processed top surface prediction map equal to 0.5 is set to 0 or 1.

In some embodiments, by using a sigmoid function, the pixel value in the processed top surface prediction map and greater than the first threshold is set to the first value and the pixel value less than the second threshold is set to the second value to obtain the top surface mask map.

In one embodiment, if the top surface prediction map is a pixel matrix of b*c, the top surface mask map is a mask matrix of b*c.

Operation 343-3: Set the pixel value in the processed facade prediction map and greater than a second threshold to the first value and set the pixel value less than the second threshold to the second value to obtain a facade mask map, the facade mask map being configured to represent the facade recognition result.

In some embodiments, the first threshold is 0.5, the first value is 1, and the second value is 0. In one embodiment, the pixel value in the processed facade prediction map and greater than 0.5 is set to 1 and the pixel value less than 0.5 is set to 0 to obtain a facade mask map, and the facade mask map is configured to represent the facade recognition result. In one embodiment, the pixel value in the processed facade prediction map and equal to the first threshold is set to the second value or the first value. To be specific, the pixel value in the processed facade prediction map equal to 0.5 is set to 0 or 1.

In some embodiments, by using the sigmoid function, the pixel value in the processed facade prediction map and greater than the first threshold is set to the first value and the pixel value less than the second threshold is set to the second value to obtain the facade mask map.

In one embodiment, if the facade prediction map is a pixel matrix of b*c, the facade mask map is a mask matrix of b*c.

In one embodiment, for the satellite image of the building, one of the buildings has a top surface recognition result and a facade recognition result. Therefore, when the top surface recognition result and the facade recognition result are spliced subsequently, there is no need to perform clustering analysis on the results again (i.e., there is no need to determine a corresponding relationship between the top surface recognition result and the facade recognition result).

In the technical solution provided in this embodiment of the present disclosure, an output layer expands a single controller branch into two, and parameters (with a dimension of x*2) of two different mask heads (result prediction networks) are generated for each building instance to output two masks (mask maps) of different categories for a same instance, i.e., a building top surface recognition result and a building lateral facade recognition result.

In addition, the top surface prediction map and the facade prediction map are first determined, a pixel value of each pixel in the top surface prediction map represents a possibility that the pixel belongs to the top surface of the building, and a pixel value of each pixel in the facade prediction map represents a possibility that the pixel belongs to the facade of the building. Therefore, through the introduction of the prediction maps, accuracy of the top surface recognition result and the facade recognition result can be further improved. At the same time, the determination of the top surface recognition result and the facade recognition result is more concrete and reasonable.

Certainly, the prediction maps are normalized, and the prediction maps are converted to mask maps, so that representation of the top surface recognition result and the facade recognition result is clearer, which is conducive to subsequent output of the top surface recognition result and the facade recognition result.

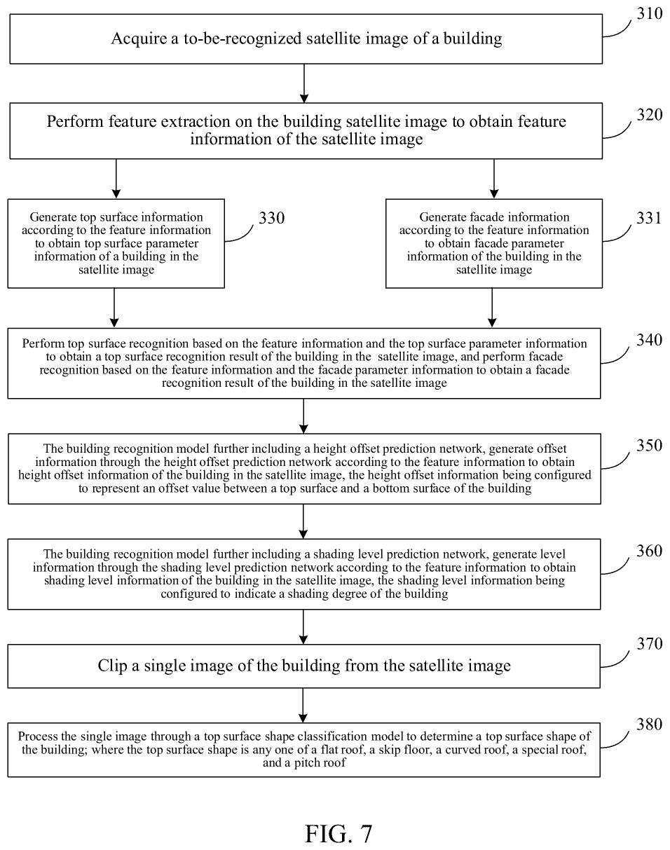

FIG. 7 is a flowchart of a building recognition method according to another embodiment of the present disclosure. Operations of the method may be performed by the model operating device introduced above. In the following method embodiments, for ease of description, the introduction is only based on an example in which the operations are performed by a “computer device”. The computer device may be used as the model operating device. The method may include at least one of the following operations (310 to 380):

Operation 310: Acquire a to-be-recognized satellite image of the building.

Operation 320: A building recognition model including: a feature extraction network, a top surface prediction network, a facade prediction network, and a result prediction network, acquire feature information of the satellite image of the building through the feature extraction network.

Operation 330: Generate top surface information through the top surface prediction network according to the feature information to obtain top surface parameter information of a building in the satellite image of the building.

Operation 331: Generate facade information through the facade prediction network according to the feature information to obtain facade parameter information of the building in the satellite image.

Operation 340: Perform top surface recognition through the result prediction network according to the feature information and the top surface parameter information to obtain a top surface recognition result of the building in the satellite image, and perform facade recognition through the result prediction network based on the feature information and the facade parameter information to obtain a facade recognition result of the building in the satellite image.

Operation 350: The building recognition model further including a height offset prediction network, generate offset information through the height offset prediction network according to the feature information to obtain height offset information of the building in the satellite image, the height offset information being configured to represent an offset value between a top surface and a bottom surface of the building.

In some embodiments, the height offset prediction network is a head network. In one embodiment, the head network of the height offset prediction network further includes at least one convolutional layer. In some embodiments, the height offset prediction network is configured to determine the offset value between the top surface and the bottom surface of the building in the satellite image according to the feature information. In one embodiment, in the satellite image of the building, a certain offset exists between the bottom surface of the building. In one embodiment, if an offset between the top surface and the bottom surface of the building in a horizontal direction is considered to be x and an offset between the top surface and the bottom surface of the building in a vertical direction is considered to be y, the height offset information may be (x, y), where x and y are positive numbers.

In some embodiments, the height offset prediction network shares at least one parameter of the facade prediction network.

In some embodiments, since the facade of the building is positively correlated with the height offset information, if a height of the facade is greater, the offset value between the top surface and the bottom surface of the building may be greater accordingly. On the contrary, if the height of the facade is smaller, the offset value between the surface and the bottom surface of the building may be smaller accordingly. Therefore, it can be considered that the facade recognition result of the building is strongly correlated with the height offset information of the building.

In some embodiments, considering that the facade recognition result of the building is strongly correlated with the height offset information of the building, the height offset prediction network shares at least one parameter of the facade prediction network. In one embodiment, the height offset prediction network includes a plurality of convolutional layers, the facade prediction network includes a plurality of convolutional layers, and the height offset prediction network shares parameters of the first convolutional layer of the facade prediction network.

In the technical solution provided in this embodiment of the present disclosure, the height offset prediction network shares at least one parameter of the facade prediction network, so that the facade recognition result of the building and the height offset information of the building are associated to some extent in a case that the facade recognition result of the building is strongly correlated with the height offset information of the building, and subsequent output of the two layers is associated with each other and promotes each other, which facilitates the model to better output the facade recognition result and the height offset information.

In addition, through the introduction of the height offset prediction network, height offset information of each building can be predicted for the satellite image of the building, which facilitates refined structural recognition of the building and improves fineness of three-dimensional reconstruction of the building.

In some embodiments, after operation 350, the method further includes operation 351 (not shown).

Operation 351: Determine a bottom surface prediction result corresponding to the top surface recognition result according to the top surface recognition result and the height offset information.

In some embodiments, the bottom surface prediction result corresponding to the top surface recognition result is determined according to the height offset information after the top surface recognition result is determined. In one embodiment, the bottom surface prediction result is obtained after the top surface recognition result is translated in the horizontal direction and the vertical direction. For example, the offset information is (x, y), and the bottom surface prediction result is obtained after the top surface recognition result is translated by x units in the horizontal direction and y units in the vertical direction. In one embodiment, the top surface recognition result and the bottom surface prediction result have a same shape and a same size.

In an embodiment, after operation 351, the method further includes at least one of operation 352 and operation 353 (not shown).

In some embodiments, before operation 352, latitude and longitude coordinate information of the bottom surface of the building is determined according to the bottom surface prediction result.

In specific implementation, the latitude and longitude coordinate information of the bottom surface of the building may be determined according to latitude and longitude coordinates of a first position in the acquired satellite image of the building, latitude and longitude spans corresponding to each pixel point, and the bottom surface prediction result of the building. In one embodiment, the first position is a center point, a vertex, or the like of the satellite image of the building.

Operation 352: Match the bottom surface prediction result with base map building block vector data to determine a matching building corresponding to at least one building included in the satellite image of the building. The base map building block vector data includes the latitude and longitude coordinate information of the bottom surface of the building.

In some embodiments, the latitude and longitude coordinate information of the bottom surface may be determined according to the bottom surface prediction result. Therefore, in operation 352, latitude and longitude coordinates of base map measurement data may be matched with the base map building block vector data. The base map building block vector data includes the latitude and longitude coordinate information of the bottom surface of the building. In one embodiment, the bottom surface prediction result is matched with the base map building block vector data to determine a matching building corresponding to at least one building included in the satellite image of the building. The matching building corresponds to the latitude and longitude coordinate information.

Operation 353: Add the top surface recognition result, the facade recognition result, and the height offset information of the matching building to the base map building block vector data of the matching building to obtain updated base map building block vector data of the matching building.

In some embodiments, building information of one building is superimposed on the base map building block vector data of the building. The building information includes, but is not limited to, the top surface recognition result, the facade recognition result, and the height offset information. In one embodiment, the building information may further include at least one of subsequent shading level information, building category information, and building top surface shape information.

Operation 360: The building recognition model further including a shading level prediction network, generate level information through the shading level prediction network according to the feature information to obtain shading level information of the building in the satellite image, the shading level information being configured to indicate a shading degree of the building.

In some embodiments, the shading level prediction network is a head network. In one embodiment, the head network of the shading level prediction network further includes at least one convolutional layer. In one embodiment, the shading level prediction network is configured to determine a shading level of a lateral facade of the building in the satellite image according to the feature information.

In some embodiments, due to issues such as orientations of the building, the lateral facade of the building corresponds to different shading levels.

In the technical solution provided in this embodiment of the present disclosure, a shading level classification branch is added to the output layer. Considering that the shading of the building is an important factor affecting color extraction of the lateral facade of the building, the shading level of the lateral facade of the building is also classified and predicted, which is divided into five categories: no shading, weak shading, medium shading, strong shading, and unclassified. Therefore, through the acquisition of the shading level information of the building, it is conducive to enriching subsequent color rendering of the facade of the building.

In some embodiments, after operation 360, the method further includes at least one of operation 361 and operation 363 (not shown).

Operation 361: Extract color information of the building in the satellite image according to the shading level information.

In some embodiments, color information of the building in the satellite image is extracted. The top surface color information of the building is determined according to the extracted color information.

Operation 362: Determine facade color information of the building according to the extracted color information in a case that shading level information satisfies a first condition.

In some embodiments, if the first condition is a shading level in the shading level information being less than a first level, extracted facade color information of the satellite image of the building is taken as the facade color information of the building. In the first possible implementation, the first level is a minimum shading level, such as no shading. In the case of no shading, the extracted facade color information of the satellite image of the building is taken as the facade color information of the building.

Operation 363: Determine facade brightness information of the building according to the shading level information and determine the facade color information of the building according to the facade brightness information and the extracted color information in a case that the shading level information satisfies a second condition.

In some embodiments, if the second condition is the shading level in the shading level information being greater than the first level, facade brightness information of the building is determined according to the shading level information, and the facade color information of the building is determined according to the facade brightness information and the extracted color information. In the first possible implementation, the first level is a minimum shading level, such as no shading. When the shading level is greater than the no-shading level, if the shading level is strong shading, the facade brightness information is determined according to the shading level. In one embodiment, there is a corresponding relationship between the facade brightness information and the shading level information. In one embodiment, the facade brightness information and the shading level information are positively correlated. In one embodiment, based on the extracted facade color information, the facade brightness information is superimposed to determine the facade color information of the building.

In the technical solution provided in this embodiment of the present disclosure, the shading level and the facade color are linked together, so that the determined facade color is more consistent with a certain situation. Brightness information is determined through the shading level, and then the facade color information is determined, so that when the determined facade color information is configured for subsequent re-rendering of a three-dimensional target building, a rendering result is more realistic and reliable, which helps reduce a difference between the rendering result and an actual building condition, and improves accuracy of rendering of the three-dimensional building model.

In some embodiments, colors of the top surface and the facade of the building may be extracted according to the image and the shading level. When there is no shading, a red-green-blue (RGB) color of the image is directly used. A higher shading level indicates that more brightness is added to the color.

Operation 370: Clip a single image of the building from the satellite image of the building.

In some embodiments, a single image of each building in the satellite image of the building may be determined according to an instance box of the building. In some embodiments, the instance box of each building in the satellite image of the building is outputted through the building recognition model.

In some embodiments, the single image of the building is manually clipped from the satellite image of the building.

Operation 380: Process the single image through a top surface shape classification model to determine a top surface shape of the building; where the top surface shape is any one of a flat roof, a skip floor, a curved roof, a special roof, and a pitch roof.

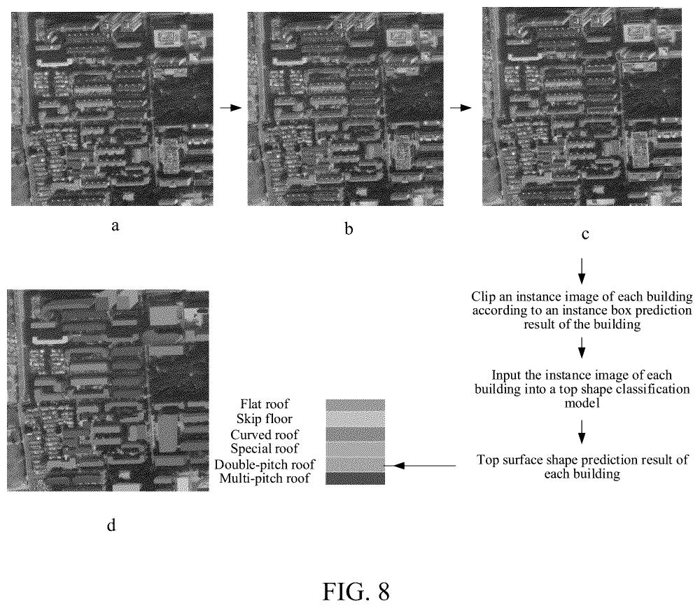

In some embodiments, the top surface shape of the building is predicted by training a top shape classification model, and a prediction result is a category such as a flat roof, a skip floor, a curved roof, a special roof, or a pitch roof. In some embodiments, as shown in FIG. 8, Subfigure a shows the satellite image of the building, Subfigure b shows the satellite image of the building annotated with building information acquired through the building recognition model, and Subfigure c shows a top surface instance box prediction result separately annotated for the satellite image of the building through the building recognition model. An instance image of each building in the satellite image of the building is clipped according to an instance box prediction result of the building. Through the top surface shape classification model, a prediction result of the top surface shape of each building is determined according to the clipped instance image of the building. Subfigure d shows the satellite image of the building annotated with the prediction result of the top surface shape of each building. In one embodiment, a satellite image of a single building is inputted into the top shape classification model, and a prediction result of a top surface shape of the single building is outputted.

In the technical solution provided in this embodiment of the present disclosure, through matching between the bottom surface and the base map building block vector data of the building, attributes such as a top surface color, a facade color, and a top surface shape may be added to the base map building block vector data, and a basis may be provided for rendering, thereby obtaining more realistic building data.

In some embodiments, after operation 380, the method further includes operation 390 (not shown).

Operation 390: Re-render a three-dimensional building model of the matching building according to the updated base map building block vector data of the matching building.

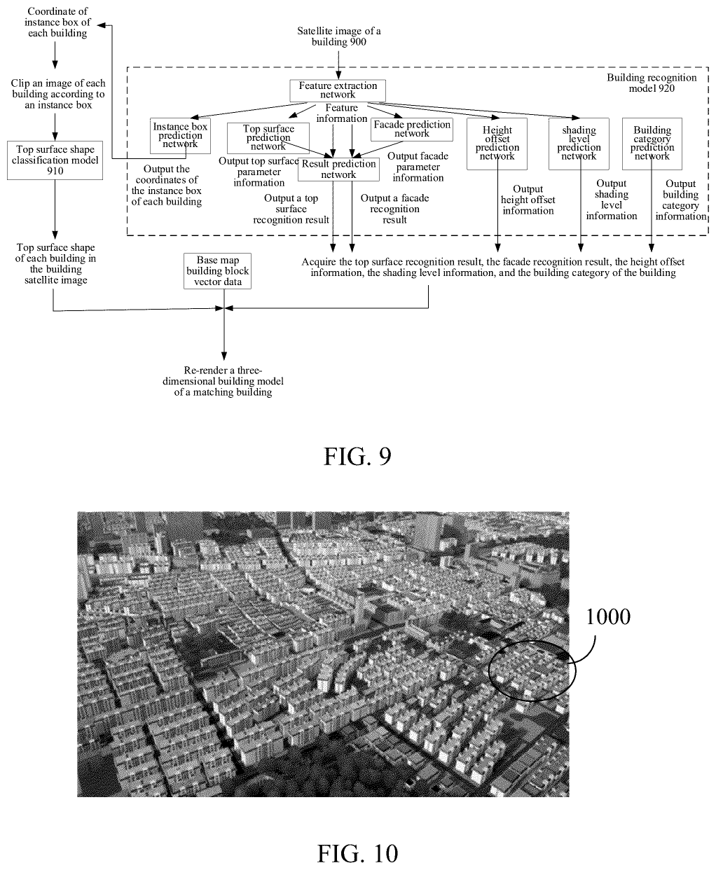

In some embodiments, as shown in FIG. 9, a satellite image of the building 900 acquires, through a building recognition model 920, a top surface recognition result, a facade recognition result, height offset information, shading level information, and building category information of each building in the satellite image of the building. A bottom surface prediction result is determined according to the height offset information and the top surface recognition result. The bottom surface prediction result is matched with base map building block vector data to determine base map building block vector data corresponding to a building in the base map building block vector data. In one embodiment, a coordinate position of an instance box of each building is predicted through an instance box prediction network in the building recognition model. An instance image (i.e., a single image) of each building is clipped from the satellite image of the building according to coordinates of the instance box of the building. After the instance image is clipped, a prediction result of a top surface shape of each building corresponding to the instance image of the building is outputted through a top surface shape classification model 910. Based on the base map building block vector data corresponding to the building, building information is superimposed, and a three-dimensional building model of the matching building is re-rendered. The building information includes the top surface recognition result, the facade recognition result, the height offset information, the shading level information, and the building category information described above and the prediction result of the top surface shape of each building. In one embodiment, FIG. 10 is a schematic diagram of a plurality of three-dimensional building models 1000 re-rendered. The plurality of three-dimensional building models 1000 are finally rendered by superimposing the top surface recognition result, the facade recognition result, the height offset information, the shading level information, the building category information, and the prediction result of the top surface shape of each building based on the building block vector data.

In the technical solution provided in this embodiment of the present disclosure, multi-dimensional fine deconstruction of the building is implemented by multi-dimensionally recognizing a top surface, a lateral facade, a height offset, a building category, and lateral facade shading intensity of the satellite image of the building and extracting a color and a top surface shape of the building according to the shading intensity. Attributes of base map data are enriched through matching with the base map data, thereby realizing more intuitive and realistic rendering.

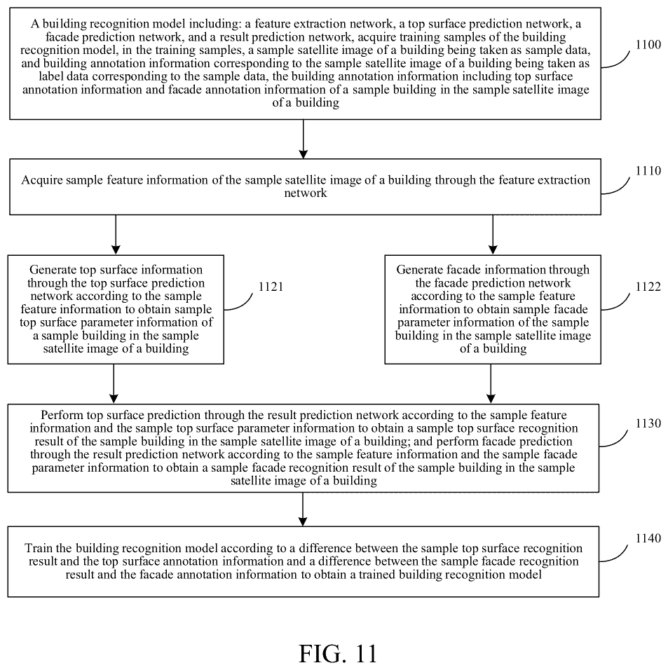

FIG. 11 is a flowchart of a method for training a building recognition model according to an embodiment of the present disclosure. Operations of the method may be performed by the model training device introduced above. In the following method embodiments, for ease of description, the introduction is only based on an example in which the operations are performed by a “computer device”. The computer device may be used as the model training device. The method may include at least one of the following operations (1100 to 1140):

Operation 1100: A building recognition model including: a feature extraction network, a top surface prediction network, a facade prediction network, and a result prediction network, acquire training samples of the building recognition model, in the training samples, a sample satellite image of the building being taken as sample data, and building annotation information corresponding to the sample satellite image of the building being taken as label data corresponding to the sample data, the building annotation information including top surface annotation information and facade annotation information of a sample building in the sample satellite image of the building.

In some embodiments, the building annotation information may further include annotation information of a center point of the sample building, annotation information of an instance box, and category information of the sample building. In one embodiment, the building recognition model may further include a center point prediction network, an instance box prediction network, and a building category prediction network.

The building recognition model is trained according to the difference between the building annotation information and an output result, to obtain a trained building recognition model.

Operation 1110: Acquire sample feature information of the sample satellite image of the building through the feature extraction network.

Operation 1121: Generate top surface information through the top surface prediction network according to the sample feature information to obtain sample top surface parameter information of a sample building in the sample satellite image of the building.

Operation 1122: Generate facade information through the facade prediction network according to the sample feature information to obtain sample facade parameter information of the sample building in the sample satellite image of the building.

Operation 1130: Perform top surface prediction through the result prediction network according to the sample feature information and the sample top surface parameter information to obtain a sample top surface recognition result of the sample building in the sample satellite image of the building; and perform facade prediction through the result prediction network according to the sample feature information and the sample facade parameter information to obtain a sample facade recognition result of the sample building in the sample satellite image of the building.

Operation 1140: Train the building recognition model according to a difference between the sample top surface recognition result and the top surface annotation information and a difference between the sample facade recognition result and the facade annotation information to obtain a trained building recognition model.

In some embodiments, after operation 1140, the method further includes operation 1150 (not shown).

Operation 1150: The building recognition model further including a height offset prediction network, the building annotation information further including height offset annotation information, generate offset information through the height offset prediction network according to the sample feature information to obtain sample height offset information of the sample building in the sample satellite image of the building, the sample height offset information being configured to represent an offset value between a top surface and a bottom surface of the sample building.

In some embodiments, operation 1150 may be implemented by training the building recognition model according to the difference between the sample top surface recognition result and the top surface annotation information, the difference between the sample facade recognition result and the facade annotation information, and a difference between the height offset information and the height offset annotation information. The difference between the height offset information and the height offset annotation information is mainly to train the height offset prediction network of the building recognition model.

In some embodiments, after operation 1140, the method further includes operation 1160 (not shown).

Operation 1160: The building recognition model further including a shading level prediction network, the building annotation information further including shading level annotation information, generate level information through the shading level prediction network according to the sample feature information to obtain sample shading level information of the sample building in the sample satellite image of the building, the sample shading level information being configured to indicate a shading degree of the sample building.

In some embodiments, operation 1150 may be implemented by training the building recognition model according to the difference between the sample top surface recognition result and the top surface annotation information, the difference between the sample facade recognition result and the facade annotation information, and a difference between the sample shading level information and the shading level annotation information. The difference between the sample shading level information and the shading level annotation information is mainly to train the shading level prediction network of the building recognition model.

Specific model processing procedures and introduction to each network may be obtained with reference to the embodiments of the model operating device above, which are not described in detail herein.

The following describes apparatus embodiments of the present disclosure, which may be configured to perform the method embodiments of the present disclosure. For details not disclosed in the apparatus embodiments of the present disclosure, refer to the method embodiments of the present disclosure.

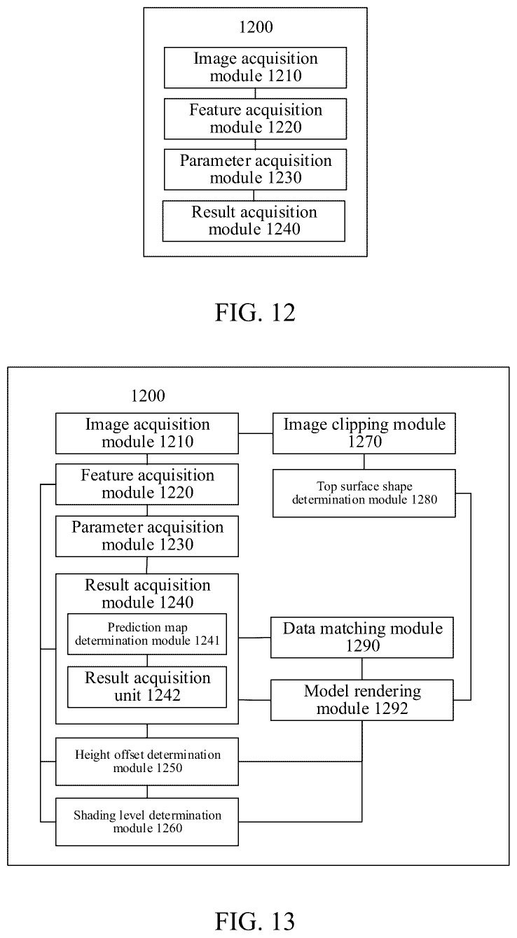

FIG. 12 is a block diagram of a building recognition apparatus according to an embodiment of the present disclosure. The apparatus 1200 may include: an image acquisition module 1210, a feature acquisition module 1220, a parameter acquisition module 1230, and a result acquisition module 1240.

The image acquisition module 1210 is configured to acquire a to-be-recognized satellite image of the building.

The feature acquisition module 1220 is configured to perform feature extraction on the satellite image of the building to obtain feature information of the satellite image of the building.

The parameter acquisition module 1230 is configured to generate top surface information according to the feature information to obtain top surface parameter information of a building in the satellite image of the building.

The parameter acquisition module 1230 is further configured to generate facade information according to the feature information to obtain facade parameter information of the building in the satellite image.

The result acquisition module 1240 is configured to perform top surface recognition based on the feature information and the top surface parameter information to obtain a top surface recognition result of the building in the satellite image, and perform facade recognition based on the feature information and the facade parameter information to obtain a facade recognition result of the building in the satellite image.

In some embodiments, as shown in FIG. 13, the result acquisition module 1240 includes a prediction map determination module 1241 and a result acquisition module 1242.

The prediction map determination module 1241 is configured to perform top surface recognition according to the feature information and the top surface parameter information to obtain a top surface prediction map of the building in the satellite image, where pixel values of pixels in the top surface prediction map are configured to determine possibilities that the pixels belong to a top surface of the building.

The prediction map determination module 1241 is further configured to perform facade recognition according to the feature information and the facade parameter information to obtain a facade prediction map of the building in the satellite image, where pixel values of pixels in the facade prediction map are configured to determine possibilities that the pixels belong to a facade of the building.

The result acquisition module 1242 is configured to obtain the top surface recognition result of the building in the satellite image according to the top surface prediction map; and obtain the facade recognition result of the building in the satellite image according to the facade prediction map.

In some embodiments, the result acquisition module 1242 is configured to normalize the pixel values of the pixels in the top surface prediction map to obtain a processed top surface prediction map; and normalize the pixel values of the pixels in the facade prediction map to obtain a processed facade prediction map.

The result acquisition module 1242 is further configured to set the pixel value in the processed top surface prediction map and greater than a first threshold to a first value and set the pixel value less than the first threshold to a second value to obtain a top surface mask map. The top surface mask map is configured to represent the top surface recognition result.

The result acquisition module 1242 is further configured to set the pixel value in the processed facade prediction map and greater than a second threshold to the first value and set the pixel value less than the second threshold to the second value to obtain a facade mask map. The facade mask map is configured to represent the facade recognition result.

In some embodiments, the feature acquisition module 1220 is configured to perform feature extraction on the satellite image of the building through the feature extraction network to obtain the feature information of the satellite image of the building;
the parameter acquisition module 1230 is configured to generate the top surface information through the top surface prediction network according to the feature information to obtain top surface parameter information of the building in the satellite image;
the parameter acquisition module 1230 is configured to generate the facade information through the facade prediction network according to the feature information to obtain facade parameter information of the building in the satellite image; and
the result acquisition module 1240 is configured to perform top surface recognition through the result prediction network based on the feature information and the top surface parameter information to obtain a top surface recognition result of the building in the satellite image, and perform facade recognition through the result prediction network based on the feature information and the facade parameter information to obtain a facade recognition result of the building in the satellite image.

In some embodiments, the building recognition model further includes a height offset prediction network. As shown in FIG. 13, the apparatus further includes a height offset determination module 1250.

The height offset determination module 1250 is configured to generate offset information through the height offset prediction network according to the feature information to obtain height offset information of the building in the satellite image. The height offset information is configured to represent an offset value between the top surface and a bottom surface of the building.

In some embodiments, the height offset prediction network shares at least one parameter of the facade prediction network.

In some embodiments, the result acquisition module 1240 is further configured to determine the bottom surface prediction result corresponding to the top surface recognition result according to the top surface recognition result and the height offset information.

In some embodiments, the building recognition model further includes a shading level prediction network. As shown in FIG. 13, the apparatus further includes a shading level determination module 1260.

The shading level determination module 1260 is configured to generate level information through the shading level prediction network according to the feature information to obtain shading level information of the building in the satellite image. The shading level information is configured to indicate a shading degree of the building.

In some embodiments, the shading level determination module 1260 is configured to extract color information of the building in the satellite image according to the shading level information.

The shading level determination module 1260 is configured to determine facade color information of the building according to the extracted color information in a case that shading level information satisfies a first condition.

The shading level determination module 1260 is further configured to determine facade brightness information of the building according to the shading level information and determine the facade color information of the building according to the facade brightness information and the extracted color information in a case that the shading level information satisfies a second condition.

In some embodiments of the present disclosure, as shown in FIG. 13, the apparatus further includes an image clipping module 1270 and a top surface shape determination module 1280.

The image clipping module 1270 is configured to clip a single image of the building from the satellite image of the building.

The top surface shape determination module 1280 is configured to process the single image through a top surface shape classification model to determine a top surface shape of the building. The top surface shape is any one of a flat roof, a skip floor, a curved roof, a special roof, and a pitch roof.

In some embodiments, as shown in FIG. 13, the apparatus further includes a data matching module 1290.

The data matching module 1290 is configured to match the bottom surface prediction result with base map building block vector data to determine a matching building corresponding to at least one building included in the satellite image of the building. The base map building block vector data includes latitude and longitude coordinate information of the bottom surface of the building.

The data matching module 1290 is further configured to add the top surface recognition result, the facade recognition result, and the height offset information of the matching building to the base map building block vector data of the matching building to obtain updated base map building block vector data of the matching building.

In some embodiments, as shown in FIG. 13, the apparatus further includes a model rendering module 1292.

The model rendering module 1292 is configured to render a three-dimensional building model of the matching building according to the updated base map building block vector data of the matching building.

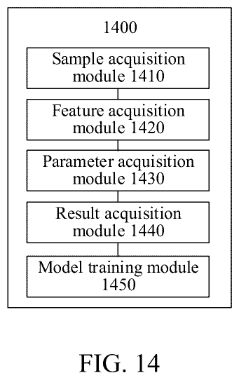

FIG. 14 is a block diagram of an apparatus for training a building recognition model according to an embodiment of the present disclosure. The building recognition model includes: a feature extraction network, a top surface prediction network, a facade prediction network, and a result prediction network. The apparatus 1400 may include: a sample acquisition module 1410, a feature acquisition module 1420, a parameter acquisition module 1430, a result acquisition module 1440, and a model training module 1450.

The sample acquisition module 1410 is configured to acquire training samples of the building recognition model, where in the training samples, a sample satellite image of the building is taken as sample data, and building annotation information corresponding to the sample satellite image of the building is taken as label data corresponding to the sample data, where the building annotation information includes top surface annotation information and facade annotation information of a sample building in the sample satellite image of the building.

The feature acquisition module 1420 is configured to acquire sample feature information of the sample satellite image of the building through the feature extraction network.

The parameter acquisition module 1430 is configured to generate top surface information through the top surface prediction network according to the sample feature information to obtain sample top surface parameter information of the sample building in the sample satellite image of the building.

The parameter acquisition module 1430 is further configured to generate facade information through the facade prediction network according to the sample feature information to obtain sample facade parameter information of the sample building in the sample satellite image of the building.

The result acquisition module 1440 is configured to perform top surface prediction through the result prediction network according to the sample feature information and the sample top surface parameter information to obtain a sample top surface recognition result of the sample building in the sample satellite image of the building; and perform facade prediction through the result prediction network according to the sample feature information and the sample facade parameter information to obtain a sample facade recognition result of the sample building in the sample satellite image of the building.

The model training module 1450 is configured to train the building recognition model according to a difference between the sample top surface recognition result and the top surface annotation information and a difference between the sample facade recognition result and the facade annotation information to obtain a trained building recognition model.

In some embodiments, the building recognition model further includes a height offset prediction network, and the building annotation information further includes height offset annotation information.

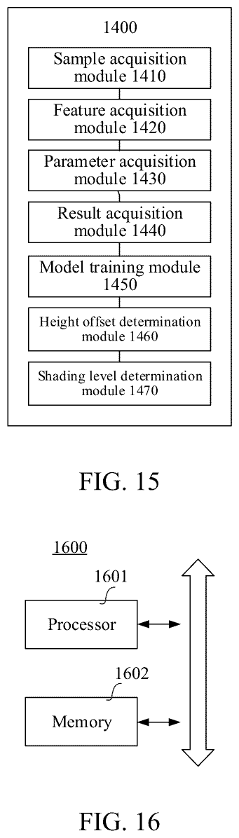

In some embodiments, as shown in FIG. 15, the apparatus further includes a height offset determination module 1460.

The height offset determination module 1460 is configured to generate offset information through the height offset prediction network according to the feature information to obtain sample height offset information of the sample building in the sample satellite image of the building. The sample height offset information is configured to represent an offset value between a top surface and a bottom surface of the sample building.

In some embodiments, the model training module 1450 is configured to train the building recognition model according to the difference between the sample top surface recognition result and the top surface annotation information, the difference between the sample facade recognition result and the facade annotation information, and a difference between the height offset information and the height offset annotation information.

In some embodiments, the building recognition model further includes a shading level prediction network, and the building annotation information further includes shading level annotation information.

In some embodiments, as shown in FIG. 15, the apparatus further includes a shading level determination module 1470.

The shading level determination module 1470 is configured to generate level information through the shading level prediction network according to the feature information to obtain sample shading level information of the sample building in the sample satellite image of the building. The sample shading level information is configured to indicate the shading degree of the sample building.

In some embodiments, the model training module 1450 is configured to train the building recognition model according to the difference between the sample top surface recognition result and the top surface annotation information, the difference between the sample facade recognition result and the facade annotation information, and a difference between the shading level information and the shading level annotation information.

When the apparatus provided in the foregoing embodiments implements the functions thereof, only division of the foregoing function modules is used as an example for description. In practical application, the foregoing functions may be allocated to and completed by different function modules according to requirements. That is, the internal structure of a device is divided into different function modules to complete all or some of the functions described above. In addition, the apparatus provided in the foregoing embodiments and the method embodiments belong to the same conception. For details of a specific implementation process, refer to the method embodiments. Details are not described herein again.

FIG. 16 is a structural block diagram of a computer device according to another embodiment of the present disclosure.

Generally, the computer device 1600 includes: a processor 1601 and a memory 1602.

The processor 1601 may include one or more processing cores, for example, a 4-core processor or a 16-core processor. The processor 1601 may be implemented in at least one hardware form of a digital signal processor (DSP), a field-programmable gate array (FPGA), and a programmable logic array (PLA). The processor 1601 may also include a main processor and a coprocessor. The main processor is a processor configured to process data in an awake state, and is also referred to as a central processing unit (CPU). The coprocessor is a low-power processor configured to process the data in a standby state. In some embodiments, the processor 1601 may be integrated with a graphics processing unit (GPU). The GPU is configured to render and draw content that needs to be displayed on a display screen. In some embodiments, the processor 1601 may further include an AI processor. The AI processor is configured to process computing operations related to machine learning.

The memory 1602 may include one or more computer-readable storage media. The computer-readable storage medium may be tangible and non-transitory. The memory 1602 may further include a high-speed random access memory (RAM) and a nonvolatile memory, for example, one or more disk storage devices or flash storage devices. In some embodiments, the non-transitory computer-readable storage medium in the memory 1602 stores a computer program, and the computer program is configured to be loaded and executed by the processor 1601 to implement the method provided in the foregoing method embodiments.

A person skilled in the art may understand that the structure shown in FIG. 16 constitutes no limitation on the computer device 1600, and the computer device may include more or fewer components than those shown in the figure, or some components may be combined, or a different component deployment may be used.

In one embodiment, a computer-readable storage medium is further provided. The storage medium stores a computer program. The computer program, when executed by a processor, implements the method for training a building recognition model described above.

In one embodiment, the computer-readable storage medium may include: a read-only memory (ROM), a RAM, a solid state drive (SSD), an optical disc, or the like. The RAM may include a resistance random access memory (ReRAM) and a dynamic random access memory (DRAM).

In one embodiment of the present disclosure, a computer program product is further provided. The computer program product includes a computer program, and the computer program is stored in a computer-readable storage medium. A processor of a computer device reads the computer program from the computer-readable storage medium, and the processor executes the computer program to cause the computer device to perform the above method.

“A plurality of” mentioned herein means two or more. “And/or” describes an association relationship for describing associated objects and represents that three relationships may exist. For example, A and/or B may represent the following three cases: only A exists, both A and B exist, and only B exists. The character “/” generally indicates an “or” relationship between the associated objects. In addition, the operation numbers described in this specification merely show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited in the embodiments of the present disclosure.

The foregoing descriptions are merely embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A building recognition method, the method being performed by a computer device, and the method comprising:
acquiring a to-be-recognized satellite image of a building;
performing feature extraction on the satellite image of the building to obtain feature information;
generating top surface information according to the feature information to obtain top surface parameter information of the building in the satellite image;
generating facade information according to the feature information to obtain facade parameter information of the building in the satellite image; and
performing top surface recognition based on the feature information and the top surface parameter information to obtain a top surface recognition result of the building in the satellite image, and performing facade recognition based on the feature information and the facade parameter information to obtain a facade recognition result of the building in the satellite image.

2. The method according to claim 1, wherein the performing top surface recognition based on the feature information and the top surface parameter information to obtain a top surface recognition result of the building in the satellite image comprises:
performing top surface recognition according to the feature information and the top surface parameter information to obtain a top surface prediction map of the building in the satellite image, wherein pixel values of pixels in the top surface prediction map are configured to determine possibilities that the pixels belong to a top surface of the building; and
obtaining the top surface recognition result of the building in the satellite image according to the top surface prediction map; and
the performing facade recognition based on the feature information and the facade parameter information to obtain a facade recognition result of the building in the satellite image comprises:
performing facade recognition according to the feature information and the facade parameter information to obtain a facade prediction map of the building in the satellite image, wherein pixel values of pixels in the facade prediction map are configured to determine possibilities that the pixels belong to a facade of the building; and
obtaining the facade recognition result of the building in the satellite image according to the facade prediction map.

3. The method according to claim 2, wherein the obtaining the top surface recognition result of the building in the satellite image according to the top surface prediction map comprises:
normalizing the pixel values of the pixels in the top surface prediction map to obtain a processed top surface prediction map; and
setting the pixel value in the processed top surface prediction map and greater than a first threshold to a first value and setting the pixel value less than the first threshold to a second value to obtain a top surface mask map, the top surface mask map being configured to represent the top surface recognition result; and
the obtaining the facade recognition result of the building in the satellite image according to the facade prediction map comprises:
normalizing the pixel values of the pixels in the facade prediction map to obtain a processed facade prediction map; and
setting the pixel value in the processed facade prediction map and greater than a second threshold to the first value and setting the pixel value less than the second threshold to the second value to obtain a facade mask map, the facade mask map being configured to represent the facade recognition result.

4. The method according to claim 1, wherein the method is implemented based on a building recognition model, the building recognition model comprising: a feature extraction network, a top surface prediction network, a facade prediction network, and a result prediction network, and the performing feature extraction on the satellite image of the building to obtain feature information of the satellite image of the building comprises:
performing feature extraction on the satellite image of the building through the feature extraction network to obtain the feature information of the satellite image of the building;
the generating top surface information according to the feature information to obtain top surface parameter information of a building in the satellite image of the building comprises:
generating the top surface information through the top surface prediction network according to the feature information to obtain the top surface parameter information of the building in the satellite image;
the generating facade information according to the feature information to obtain facade parameter information of the building in the satellite image comprises:
generating the facade information through the facade prediction network according to the feature information to obtain the facade parameter information of the building in the satellite image; and the performing top surface recognition based on the feature information and the top surface parameter information to obtain a top surface recognition result of the building in the satellite image, and performing facade recognition based on the feature information and the facade parameter information to obtain a facade recognition result of the building in the satellite image comprises:
performing top surface recognition through the result prediction network based on the feature information and the top surface parameter information to obtain the top surface recognition result of the building in the satellite image, and performing facade recognition through the result prediction network based on the feature information and the facade parameter information to obtain the facade recognition result of the building in the satellite image.

5. The method according to claim 4, wherein the building recognition model further comprises a height offset prediction network, and the method further comprises:
generating offset information through the height offset prediction network according to the feature information to obtain height offset information of the building in the satellite image, the height offset information being configured to represent an offset value between a top surface and a bottom surface of the building.

6. The method according to claim 5, wherein the height offset prediction network shares at least one parameter of the facade prediction network.

7. The method according to claim 5, wherein the method further comprises:
determining a bottom surface prediction result corresponding to the top surface recognition result according to the top surface recognition result and the height offset information.

8. The method according to claim 4, wherein the building recognition model further comprises a shading level prediction network, and the method further comprises:
generating level information through the shading level prediction network according to the feature information to obtain shading level information of the building in the satellite image, the shading level information being configured to indicate a shading degree of the building.

9. The method according to claim 8, wherein the method further comprises:
extracting color information of the building in the satellite image according to the shading level information;
determining facade color information of the building according to the extracted color information in a case that the shading level information satisfies a first condition; and
determining facade brightness information of the building according to the shading level information and determining the facade color information of the building according to the facade brightness information and the extracted color information in a case that the shading level information satisfies a second condition.

10. The method according to claim 1, wherein the method further comprises:
clipping a single image of the building from the satellite image of the building; and
processing the single image through a top surface shape classification model to determine a top surface shape of the building; wherein the top surface shape is any one of a flat roof, a skip floor, a curved roof, a special roof, and a pitch roof.

11. The method according to claim 7, wherein the method further comprises:
matching the bottom surface prediction result with base map building block vector data to determine a matching building corresponding to the building comprised in the satellite image of the building, wherein the base map building block vector data comprises latitude and longitude coordinate information of the bottom surface of the building; and
adding the top surface recognition result, the facade recognition result, and the height offset information of the matching building to the base map building block vector data of the matching building to obtain updated base map building block vector data of the matching building.

12. The method according to claim 11, wherein the method further comprises:
rendering a three-dimensional building model of the matching building according to the updated base map building block vector data of the matching building.

13. A method for training a building recognition model, the method being performed by a computer device, the building recognition model comprising: a feature extraction network, a top surface prediction network, a facade prediction network, and a result prediction network, and the method comprising:
acquiring training samples of the building recognition model, in the training samples, a sample satellite image of the building being taken as sample data, and building annotation information corresponding to the sample satellite image of the building being taken as label data corresponding to the sample data, the building annotation information comprising top surface annotation information and facade annotation information of a sample building in the sample satellite image of the building;
acquiring sample feature information of the sample satellite image of the building through the feature extraction network;
generating top surface information through the top surface prediction network according to the sample feature information to obtain sample top surface parameter information of the sample building in the sample satellite image of the building;
generating facade information through the facade prediction network according to the sample feature information to obtain sample facade parameter information of the sample building in the sample satellite image of the building;
performing top surface prediction through the result prediction network according to the sample feature information and the sample top surface parameter information to obtain a sample top surface recognition result of the sample building in the sample satellite image of the building;
performing facade prediction through the result prediction network according to the sample feature information and the sample facade parameter information to obtain a sample facade recognition result of the sample building in the sample satellite image of the building; and
training the building recognition model according to a difference between the sample top surface recognition result and the top surface annotation information and a difference between the sample facade recognition result and the facade annotation information to obtain a trained building recognition model.

14. The method according to claim 13, wherein the building recognition model further comprises a height offset prediction network, the building annotation information further comprises height offset annotation information, and the method further comprises:
generating offset information through the height offset prediction network according to the feature information to obtain sample height offset information of the sample building in the sample satellite image of the building, the sample height offset information being configured to represent an offset value between a top surface and a bottom surface of the sample building; and
the training the building recognition model according to a difference between the sample top surface recognition result and the top surface annotation information and a difference between the sample facade recognition result and the facade annotation information to obtain a trained building recognition model comprises:
training the building recognition model according to the difference between the sample top surface recognition result and the top surface annotation information, the difference between the sample facade recognition result and the facade annotation information, and a difference between the height offset information and the height offset annotation information.

15. The method according to claim 13, wherein the building recognition model further comprises a shading level prediction network, the building annotation information further comprises shading level annotation information, and the method further comprises:
generating level information through the shading level prediction network according to the feature information to obtain sample shading level information of the sample building in the sample satellite image of the building, the sample shading level information being configured to indicate a shading degree of the sample building; and
the training the building recognition model according to a difference between the sample top surface recognition result and the top surface annotation information and a difference between the sample facade recognition result and the facade annotation information to obtain a trained building recognition model comprises:
training the building recognition model according to the difference between the sample top surface recognition result and the top surface annotation information, the difference between the sample facade recognition result and the facade annotation information, and a difference between the shading level information and the shading level annotation information.

16. A computer device, the computer device comprising a processor and a memory, the memory storing a computer program, the computer program being loaded and executed by the processor to implement a building recognition method, the method comprising:
acquiring a to-be-recognized satellite image of a building;
performing feature extraction on the satellite image of the building to obtain feature information;
generating top surface information according to the feature information to obtain top surface parameter information of the building in the satellite image;
generating facade information according to the feature information to obtain facade parameter information of the building in the satellite image; and
performing top surface recognition based on the feature information and the top surface parameter information to obtain a top surface recognition result of the building in the satellite image, and performing facade recognition based on the feature information and the facade parameter information to obtain a facade recognition result of the building in the satellite image.

17. The computer device according to claim 16, wherein the performing top surface recognition based on the feature information and the top surface parameter information to obtain a top surface recognition result of the building in the satellite image comprises:
performing top surface recognition according to the feature information and the top surface parameter information to obtain a top surface prediction map of the building in the satellite image, wherein pixel values of pixels in the top surface prediction map are configured to determine possibilities that the pixels belong to a top surface of the building; and
obtaining the top surface recognition result of the building in the satellite image according to the top surface prediction map; and
the performing facade recognition based on the feature information and the facade parameter information to obtain a facade recognition result of the building in the satellite image comprises:
performing facade recognition according to the feature information and the facade parameter information to obtain a facade prediction map of the building in the satellite image, wherein pixel values of pixels in the facade prediction map are configured to determine possibilities that the pixels belong to a facade of the building; and
obtaining the facade recognition result of the building in the satellite image according to the facade prediction map.

18. The computer device according to claim 17, wherein the obtaining the top surface recognition result of the building in the satellite image according to the top surface prediction map comprises:
normalizing the pixel values of the pixels in the top surface prediction map to obtain a processed top surface prediction map; and
setting the pixel value in the processed top surface prediction map and greater than a first threshold to a first value and setting the pixel value less than the first threshold to a second value to obtain a top surface mask map, the top surface mask map being configured to represent the top surface recognition result; and
the obtaining the facade recognition result of the building in the satellite image according to the facade prediction map comprises:
normalizing the pixel values of the pixels in the facade prediction map to obtain a processed facade prediction map; and
setting the pixel value in the processed facade prediction map and greater than a second threshold to the first value and setting the pixel value less than the second threshold to the second value to obtain a facade mask map, the facade mask map being configured to represent the facade recognition result.

19. The computer device according to claim 16, wherein the method is implemented based on a building recognition model, the building recognition model comprising: a feature extraction network, a top surface prediction network, a facade prediction network, and a result prediction network, and the performing feature extraction on the satellite image of the building to obtain feature information of the satellite image of the building comprises:
performing feature extraction on the satellite image of the building through the feature extraction network to obtain the feature information of the satellite image of the building;
the generating top surface information according to the feature information to obtain top surface parameter information of a building in the satellite image of the building comprises:
generating the top surface information through the top surface prediction network according to the feature information to obtain the top surface parameter information of the building in the satellite image;
the generating facade information according to the feature information to obtain facade parameter information of the building in the satellite image comprises:
generating the facade information through the facade prediction network according to the feature information to obtain the facade parameter information of the building in the satellite image; and the performing top surface recognition based on the feature information and the top surface parameter information to obtain a top surface recognition result of the building in the satellite image, and performing facade recognition based on the feature information and the facade parameter information to obtain a facade recognition result of the building in the satellite image comprises:
performing top surface recognition through the result prediction network based on the feature information and the top surface parameter information to obtain the top surface recognition result of the building in the satellite image, and performing facade recognition through the result prediction network based on the feature information and the facade parameter information to obtain the facade recognition result of the building in the satellite image.

20. The computer device according to claim 19, wherein the building recognition model further comprises a height offset prediction network, and the method further comprises:
generating offset information through the height offset prediction network according to the feature information to obtain height offset information of the building in the satellite image, the height offset information being configured to represent an offset value between a top surface and a bottom surface of the building.
